(19) United States
(12) Patent Application Publication
(10) Pub. No.: US 2025/0031928 A1
(43) Pub. Date: Jan. 30, 2025

(54) Vacuum Cleaner Conduit Equipped With An Articulation Device

(71) Applicant: SEB S.A., Ecully (FR)

(72) Inventors: Christelle Philippe, Ecully Cedex (FR); Jean Damien Vivier, Ecully Cedex (FR); Alex Anquetin, Ecully Cedex (FR)

(73) Assignee: SEB S.A., Ecully (FR)

(21) Appl. No.: 18/785,000

(22) Filed: Jul. 26, 2024

(30) Foreign Application Priority Data
Jul. 26, 2023 (FR) 23/08048

(51) Int. Cl. A47L 9/24

(52) U.S. Cl. CPC A47L 9/242; A47L 9/248

(57) ABSTRACT

The vacuum cleaner conduit (5) comprises first and second rigid conduit parts (7, 8); an articulation device (9) configured to allow a pivoting of the first and second rigid conduit parts (7, 8) between unfolded and folded configurations; a locking member configured to lock the first and second rigid conduit parts (7, 8) in the unfolded configuration; an actuating member (34) configured to move the locking member from a locking position to a release position; and a covering member (39) configured to cover at least one distal end portion of the locking member and to extend at least partly under said distal end portion.

### TECHNICAL FIELD

The present invention concerns the field of vacuum cleaner conduits, and in particular vacuum cleaners equipped with such vacuum cleaner conduits.

### STATE OF THE ART

A vacuum cleaner comprises, in a known manner, a vacuum cleaner case equipped with a suction unit, a nozzle configured to be in contact with a floor to be cleaned, and a vacuum cleaner conduit fluidly and mechanically connecting the vacuum cleaner case to the nozzle and defining an air flow passage.

In order to facilitate the storage of the vacuum cleaner or a cleaning with the vacuum cleaner under furniture, the vacuum cleaner conduit advantageously comprises:
a first rigid conduit part and a second rigid conduit part,
an articulation device connecting the first and second rigid parts together and configured to allow a pivoting of the first rigid conduit part relative to the second rigid conduit part about an articulation axis and between an unfolded configuration in which the first and second rigid conduit parts are substantially aligned with each other and a folded configuration in which the first and second rigid conduit parts define between them an angle less than 180°,
a locking member configured to lock the first and second rigid conduit parts in the unfolded configuration, the locking member being pivotally mounted on one of the first and second rigid conduit parts about a pivot axis and between a locking position in which the locking member is configured to cooperate with the other of the first and second rigid conduit parts so as to lock the first and second rigid conduit parts in the unfolded configuration, and a release position in which the locking member is configured to release the other of the first and second rigid conduit parts so as to allow a pivoting of the first and second rigid conduit parts in the folded configuration, and
an actuating member secured in movement to the locking member and pivotally mounted about the pivot axis and between a rest position and an unlocking position, the actuating member being diametrically opposed to the articulation device (and therefore located in a lower part of the vacuum cleaner conduit) and the vacuum cleaner conduit being configured such that a displacement of the actuating member from the rest position to the unlocking position causes a displacement of the locking member from the locking position to the release position.

Such a configuration of the vacuum cleaner conduit allows a user, with the same hand, to move the locking member into the release position by exerting a pressure on the actuating member, then to initiate a pivoting of the first rigid conduit part relative to the second rigid conduit part towards the folded configuration in which the first and second rigid conduit parts define between them an angle less than 180°. The action of exerting a pressure on the actuating part, to move the locking member towards the release position, may be done for example with the index finger. The action of pushing the first or the second rigid conduit part, to initiate a pivoting of the first rigid conduit part relative to the second rigid conduit part towards the folded configuration, may be done for example with the palm of the same hand.

However, the locking member being exposed, the risks of pinching a user's fingers, when the locking member pivots between the locking position and the release position, are high.

In addition, when using the vacuum cleaner conduit in the unfolded configuration, the locking member is likely to snag external elements, which may lead to deterioration of the locking member, or even seizing of the locking member.

### SUMMARY OF THE INVENTION

The present invention aims to remedy all or part of these drawbacks.

The technical problem underlying the invention consists in particular of providing a vacuum cleaner conduit which is simple, reliable and ergonomic in structure, while allowing a safe handling of the vacuum cleaner conduit.

To this end, the present invention concerns a vacuum cleaner conduit defining an air flow passage and comprising:
a first rigid conduit part and a second rigid conduit part,
an articulation device connecting the first and second rigid conduit parts together, the articulation device including an articulation axis and being configured to allow a pivoting of the first rigid conduit part relative to the second rigid conduit part about the articulation axis and between an unfolded configuration in which the first and second rigid conduit parts are substantially aligned with each other and a folded configuration in which the first and second rigid conduit parts define between them an angle less than 180°,
a locking member configured to lock the first and second rigid conduit parts in the unfolded configuration, the locking member being pivotally mounted on one of the first and second rigid conduit parts about a pivot axis which is substantially parallel to the articulation axis and being configured to pivot between a locking position in which the locking member is configured to cooperate with the other of the first and second rigid conduit parts so as to lock the first and second rigid conduit parts in the unfolded configuration, and a release position in which the locking member is configured to release the other of the first and second rigid conduit parts so as to allow a pivoting of the first and second rigid conduit parts in the folded configuration, and
an actuating member secured in movement to the locking member and including an actuating part configured to be actuated manually by a user, the locking member and the actuating part being substantially diametrically opposed to the articulation device relative to a central longitudinal axis of the vacuum cleaner conduit when the first and second rigid conduit parts are in the unfolded configuration, the actuating member being pivotally mounted about the pivot axis between a rest position and an unlocking position, the vacuum cleaner conduit being configured such that a displacement of the actuating member from the rest position to the unlocking position causes a displacement of the locking member from the locking position to the release position,
The vacuum cleaner conduit includes a covering member, such as a covering hood, configured to cover at least a distal end portion, also called free end portion, of the locking member, the covering member including a main covering wall which is configured such that, when the first and second rigid conduit parts are in the unfolded configuration, the distal end portion of the locking member is disposed between the main covering wall and the other of the first and second rigid conduit parts.

The presence of such a covering member considerably limits, on the one hand, the risks of the locking member snagging with external elements when using the vacuum cleaner conduit in the unfolded configuration, and therefore the risks of seizure of the locking member, and, on the other hand, the risks of pinching a user's fingers when the locking member pivots between the locking position and the release position.

Thus, the vacuum cleaner conduit according to the present invention has an increased safety of use and an increased reliability compared to the vacuum cleaner conduits of the prior art.

The vacuum cleaner conduit may also have one or more of the following characteristics, taken alone or in combination.

According to one embodiment of the invention, when the first and second rigid conduit parts are in the unfolded configuration, the radial distance between an internal surface of the main covering wall and an outer surface of the other of the first and second rigid conduit parts is sufficient to allow a deflection of the distal end portion of the locking member when the locking member is moved from the locking position to the release position.

According to one embodiment of the invention, the main covering wall is configured to extend under the locking member when the vacuum cleaner conduit is in a normal configuration of use.

According to one embodiment of the invention, the actuating part includes a rear transverse edge which defines the rear transverse edge of the actuating member.

According to one embodiment of the invention, the actuating part has a first longitudinal dimension, measured parallel to the central longitudinal axis of the vacuum cleaner conduit in the unfolded configuration of the first and second rigid conduit parts, and the locking member has a second longitudinal dimension, measured parallel to the central longitudinal axis of the vacuum cleaner conduit in the unfolded configuration of the first and second rigid conduit parts, which is less than the first longitudinal dimension.

According to one embodiment of the invention, the actuating part has a longitudinal dimension, measured parallel to the central longitudinal axis of the vacuum cleaner conduit in the unfolded configuration of the first and second rigid conduit parts, and the locking member has a transverse dimension, measured perpendicular to a median longitudinal plane of the vacuum cleaner conduit in the unfolded configuration of the first and second rigid conduit parts, which is less than the longitudinal dimension of the actuating part.

According to one embodiment of the invention, the actuating part is configured to be located entirely set back from a plane which is parallel to the articulation axis and which contains the central longitudinal axis of the vacuum cleaner conduit when the first and second rigid conduit parts are in the unfolded configuration.

According to one embodiment of the invention, the actuating member extends substantially in the extension of the locking member.

According to one embodiment of the invention, the actuating part and the locking member are substantially aligned in a longitudinal direction. In other words, the actuating part has a first median longitudinal plane and the locking member has a second median longitudinal plane which coincides with the first median longitudinal plane.

According to one embodiment of the invention, the actuating member extends longitudinally beyond the covering member.

According to one embodiment of the invention, the actuating part is located entirely outside the covering member. In other words, the actuating part is not covered by the covering member. These arrangements ensure an easy handling of the actuating part by a user.

According to one embodiment of the invention, the actuating part extends opposite the locking member relative to the pivot axis.

According to one embodiment of the invention, the actuating member is configured to be moved into the unlocking position when a user exerts a pressure on the actuating part.

According to one embodiment of the invention, the actuating part includes a bearing surface against which a user is able to exert a bearing force so as to move the actuating member into the unlocking position, the bearing surface being located set back from or being substantially flush with an outer surface of the main covering wall when the actuating member occupies the rest position. Such a configuration of the actuating part limits the risks of the actuating part snagging with external elements when using the vacuum cleaner conduit in the unfolded configuration, and therefore the risks of unintended displacement of the actuating member towards the unlocking position.

According to one embodiment of the invention, the covering member is further configured to laterally cover the locking member.

According to one embodiment of the invention, the actuating part includes two outer lateral surfaces which are substantially flush respectively with two outer lateral surfaces of the covering member. Such a configuration of the actuating part further limits the risks of the actuating part snagging with external elements when using the vacuum cleaner conduit in the unfolded configuration, and therefore the risks of unintended displacement of the actuating member towards the unlocking position, and also limits the risk of pinching a user's fingers when the actuating member pivots between the rest position and the unlocking position.

According to one embodiment of the invention, each outer lateral surface of the actuating part is substantially parallel to the respective outer lateral surface of the covering member. Such a configuration of the actuating part further limits the risks of unintended displacement of the actuating member towards the unlocking position.

According to one embodiment of the invention, the actuating part includes an inner face which is located facing one of the first and second rigid conduit parts, the inner face of the actuating part being concave and rounded. Such a configuration of the actuating member makes it possible to increase the displacement stroke, namely the deflection, of the actuating member during its displacements between the rest and unlocking positions, while limiting the bulk of the actuating member. Indeed, if the lower face of the actuating part were flat, the actuating part would abut against an external wall of one of the first and second rigid conduit parts after only a short displacement stroke of the actuating member. However, a significant displacement stroke for the actuating member makes it possible to increase for example the dimensions of a locking finger provided on the locking member, and therefore to ensure a better locking of the first and second rigid conduit parts in the unfolded configuration.

According to one embodiment of the invention, the inner face of the actuating part has a curvature substantially complementary to the outer curvature of the rigid conduit part facing which it is located.

According to one embodiment of the invention, the bearing surface is convex and rounded.

According to one embodiment of the invention, the actuating part is curved and extends around a portion of the outer periphery of one of the first and second rigid conduit parts. Such an embodiment makes it possible to limit the bulk of the unlocking member and, consequently, of the vacuum cleaner conduit.

According to one embodiment of the invention, the actuating member and the locking member are pivotally mounted on the first rigid conduit part, the covering member being fastened to the first rigid conduit part. Thus, when the first and second rigid conduit parts are in the unfolded configuration, the distal end portion of the locking member is disposed between the main covering wall and the second rigid conduit part, and is more particularly disposed radially, relative to a central axis of the second rigid conduit part, between the main covering wall and the second rigid conduit part.

According to one embodiment of the invention, the main covering wall extends parallel to a central axis of the first rigid conduit part.

According to one embodiment of the invention, the second rigid conduit part and the covering member delimit, when the first and second rigid conduit parts are in the unfolded configuration, an internal housing in which is housed, and for example entirely housed, the locking member. Such a configuration of the covering member further limits the risk of the locking member seizing and a user's fingers being pinched when the locking member moves between the locking position and the release position. Advantageously, the internal housing extends radially, relative to a central axis of the second rigid conduit part, between the covering member and the second rigid conduit part, and the distal end portion of the locking member is configured to move in said internal housing.

According to one embodiment of the invention, the covering member is configured to completely cover a lower face of the locking member.

According to one embodiment of the invention, the covering member extends longitudinally beyond the pivot axis of the locking member.

According to one embodiment of the invention, the covering member is configured to make the locking member inaccessible when the first and second rigid conduit parts occupy the unfolded configuration.

According to one embodiment of the invention, the actuating member includes a connecting part connecting the actuating part to the locking member.

According to one embodiment of the invention, the actuating member includes a transverse shoulder which separates the connecting part and the actuating part and which is configured such that a lower surface of the connecting part is raised relative to the bearing surface, that is to say is offset upwards relative to the bearing surface.

According to one embodiment of the invention, the actuating part has a longitudinal dimension greater than the longitudinal dimension of the connecting part.

According to one embodiment of the invention, the locking member and the actuating member are made in one single piece. Such a configuration of the vacuum cleaner conduit facilitates the assembly of the vacuum cleaner conduit, and reduces its manufacturing costs.

According to one embodiment of the invention, the articulation device is configured to be located above a portion of the air flow passage which extends close to the articulation device, when the vacuum cleaner conduit is under normal conditions of use. In other words, the articulation device is configured to be oriented upwards, that is to say to be directly visible to a user, when the vacuum cleaner conduit is in normal conditions of use.

According to one embodiment of the invention, the vacuum cleaner conduit includes at least one biasing element, such as a biasing spring, configured to bias the actuating member into the rest position and/or the locking member into the locking position.

According to one embodiment of the invention, the first rigid conduit part is configured to be fluidly connected to a vacuum cleaner case equipped with a suction unit, and the second rigid conduit part is configured to be fluidly connected to a nozzle configured to be in contact with a floor to be cleaned.

According to one embodiment of the invention, the vacuum cleaner conduit includes a flexible conduit connecting the first and second rigid conduit parts and at least partially defining the air flow passage.

According to one embodiment of the invention, the articulation device is configured to be located above the flexible conduit when the vacuum cleaner conduit is under normal conditions of use. Advantageously, the articulation axis does not intersect with the flexible conduit.

According to one embodiment of the invention, the flexible conduit includes a flexible tubular part, a first fastening ring which is fastened to a first end portion of the flexible tubular part and which is configured to be removably fastened to the first rigid conduit part, and a second fastening ring which is fastened to a second end portion of the flexible tubular part and which is configured to be removably fastened to the second rigid conduit part. Such a configuration of the flexible conduit allows a dismantling of the latter, in particular with a view to cleaning it, removing large waste stuck in the flexible conduit or even replacing it in the event of damage.

According to one embodiment of the invention, the first fastening ring includes a first locking device configured to reversibly lock the first fastening ring on the first rigid conduit part, and the second fastening ring includes a second locking device configured to reversibly lock the second fastening ring on the second rigid conduit part.

According to one embodiment of the invention, the vacuum cleaner conduit includes a first suction tube fluidly and mechanically connected to the first rigid conduit part, and a second suction tube fluidly and mechanically connected to the second rigid conduit part.

According to one embodiment of the invention, the first suction tube is configured to be fluidly and mechanically connected to the vacuum cleaner case, and the second suction tube is configured to be fluidly and mechanically connected to the nozzle.

The present invention further concerns a vacuum cleaner including:
a vacuum cleaner case equipped with a suction unit,
a nozzle configured to be in contact with a floor to be cleaned, and
a vacuum cleaner conduit according to the present invention, the vacuum cleaner conduit mechanically and fluidly connecting the vacuum cleaner case to the nozzle.

The vacuum cleaner may for example be an upright vacuum cleaner or a canister vacuum cleaner.

According to one embodiment of the invention, the vacuum cleaner further includes a gripping crosshead and a flexible suction conduit which are disposed between the vacuum cleaner conduit and the vacuum cleaner case and which are configured to mechanically and fluidly connect the vacuum cleaner case to the nozzle.

### BRIEF DESCRIPTION OF THE FIGURES

In any case, the invention will be clearly understood with the aid of the description which follows with reference to the appended schematic drawings representing, by way of non-limiting example, an embodiment of this vacuum cleaner conduit.

FIG. 1 is a perspective view of a vacuum cleaner according to the invention.

FIG. 2 is a partial side perspective view of a vacuum cleaner conduit belonging to the vacuum cleaner of FIG. 1, showing the vacuum cleaner conduit in the unfolded configuration.

FIG. 3 is a partial bottom view of the vacuum cleaner conduit of FIG. 2.

FIG. 4 is a partial top view of the vacuum cleaner conduit of FIG. 2.

FIG. 5 is a partial side perspective view of the vacuum cleaner conduit of FIG. 2, showing the vacuum cleaner conduit in the unfolded configuration.

FIG. 6 is a partial bottom perspective view of the vacuum cleaner conduit of FIG. 2, showing the vacuum cleaner conduit in the unfolded configuration.

FIG. 7 is a partial top perspective view of the vacuum cleaner conduit of FIG. 2.

FIG. 8 is a perspective view of a locking member, an actuating member and a covering member belonging to the vacuum cleaner conduit of FIG. 2.

FIG. 9 is a top view of the locking member, the actuating member and the covering member of FIG. 8.

FIG. 10 is a rear perspective view of the locking member, the actuating member and the covering member of FIG. 8.

FIG. 11 is a perspective view of the vacuum cleaner conduit of FIG. 2, showing the vacuum cleaner conduit in the unfolded configuration and a flexible conduit which is withdrawn out of first and second rigid conduit parts belonging to the vacuum cleaner conduit.

FIG. 12 is a longitudinal sectional view of the vacuum cleaner conduit of FIG. 2, showing the locking member in the locking position.

FIG. 13 is a longitudinal sectional view of the vacuum cleaner conduit of FIG. 2, showing the vacuum cleaner conduit in the folded configuration.

### DETAILED DESCRIPTION

In this document, the terms “substantially flush” mean two surfaces which are flush or which have an offset less than 3 mm, and for example less than 1 mm.

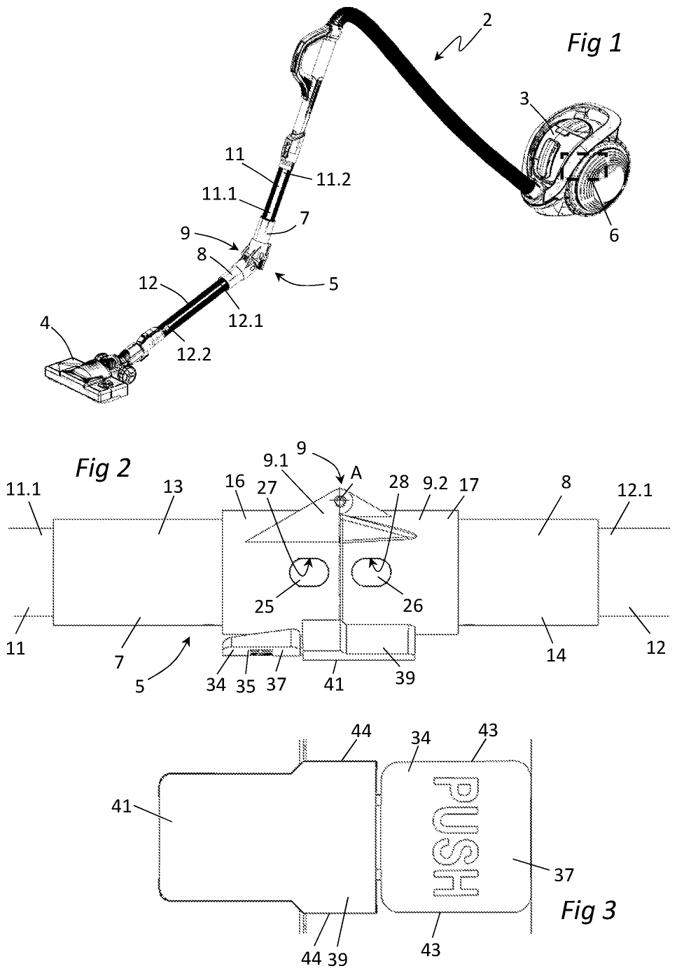

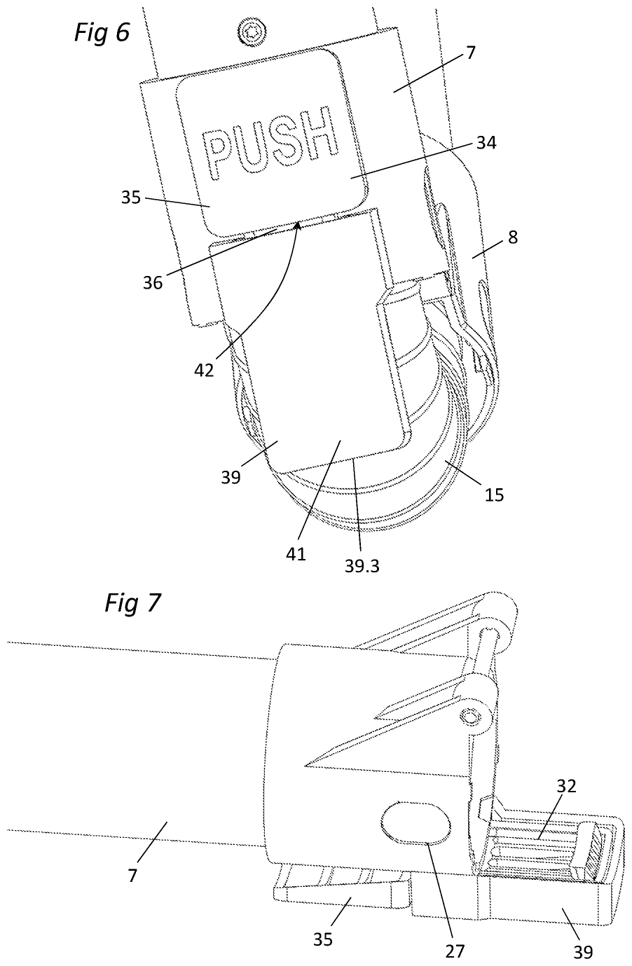

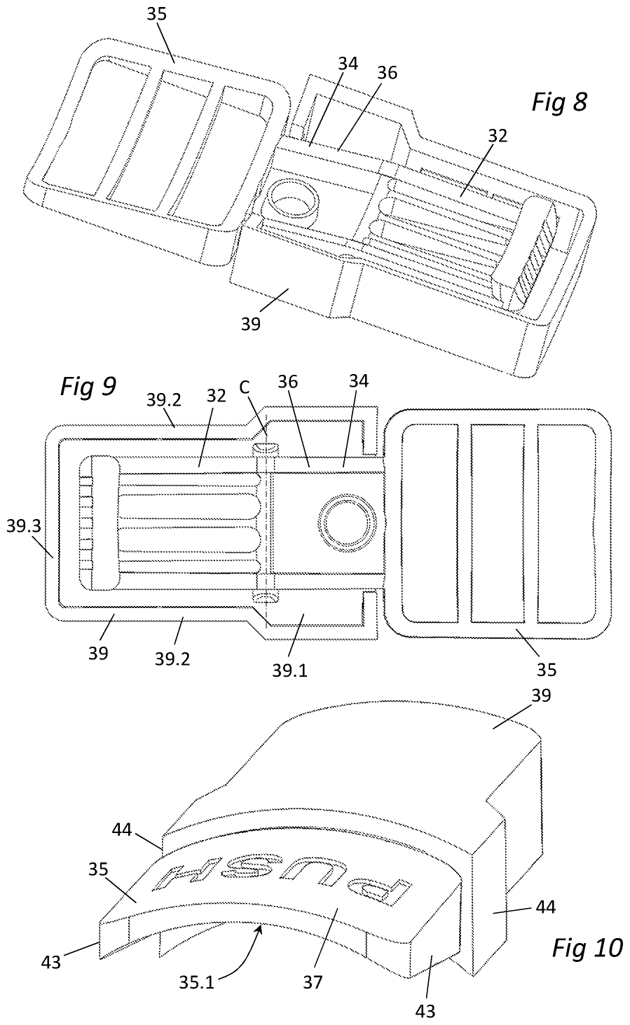

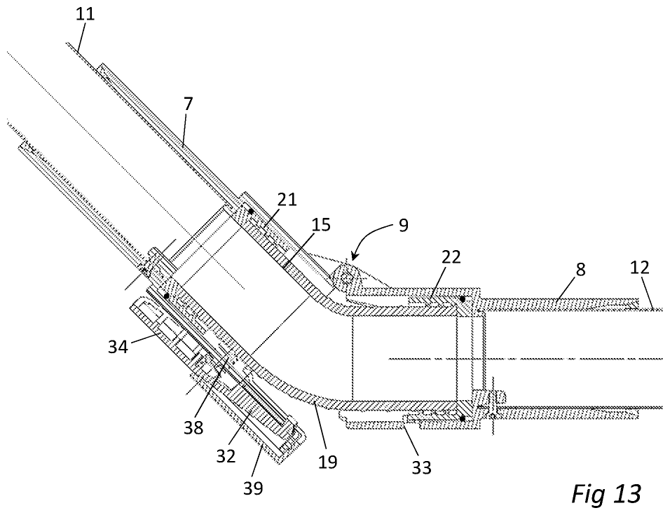

FIGS. 1 to 13 represent a vacuum cleaner 2, and more particularly a canister vacuum cleaner, which includes a vacuum cleaner case 3, a nozzle 4 configured to be in contact with a floor to be cleaned, and a vacuum cleaner conduit 5 fluidly and mechanically connecting the vacuum cleaner case 3 to the nozzle 4. The vacuum cleaner case 3 is equipped, in a known manner, in particular with a suction unit 6 which may for example include an electric motor-fan, and with a device for waste separation and storage.

As shown in FIG. 2, the vacuum cleaner conduit 5 comprises a first rigid conduit part 7, a second rigid conduit part 8, and an articulation device 9 connecting the first and second rigid conduit parts 7, 8 together.

The articulation device 9 is configured to allow a pivoting of the first rigid conduit part 7 relative to the second rigid conduit part 8 about an articulation axis A and between an unfolded configuration (see FIG. 2) in which the first and second rigid conduit parts 7, 8 are aligned with each other and a folded configuration (see FIG. 5) in which the first and second rigid conduit parts 7, 8 define between them an angle less than 180°. Advantageously, the articulation device 9 is configured to be oriented upwards, that is to say to face a user, when the vacuum cleaner conduit 5 is in normal conditions of use, and is also configured such that the articulation axis A does not intersect with the first and second rigid conduit parts 7, 8.

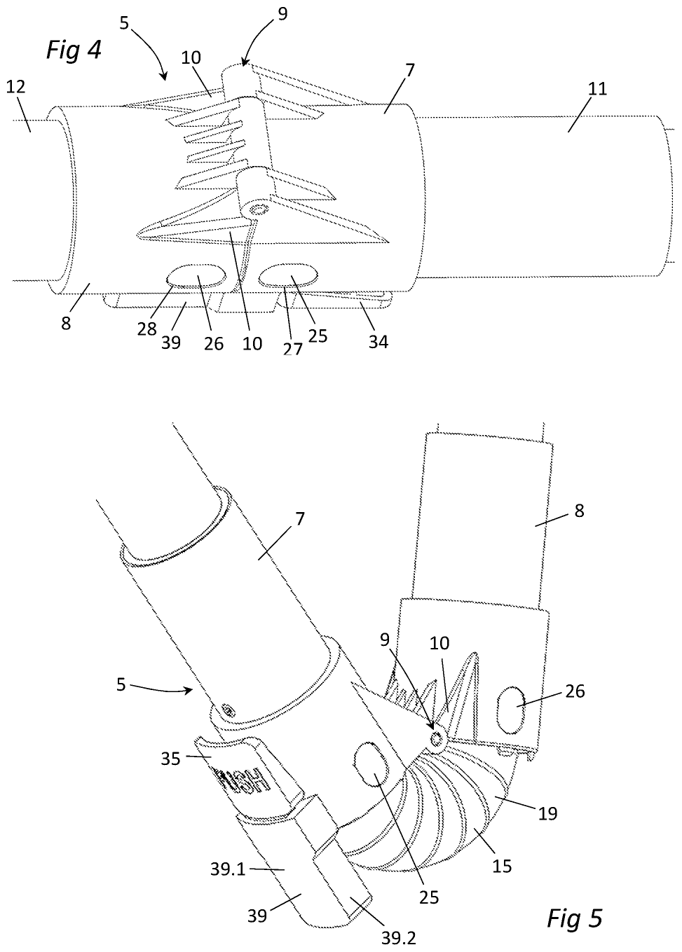

According to the embodiment represented in the figures, the articulation device 9 includes a first hinge part 9.1 fastened to an external surface of the first rigid conduit part 7, and a second hinge part 9.2 fastened to an external surface of the second rigid conduit part 8. Advantageously, the second rigid conduit part 8 includes two lateral protective ribs 10 which are located respectively on either side of the second hinge part 9.2 (see FIGS. 4 and 5) and which are configured to avoid pinching or sticking of external objects at the articulation device 9.

The vacuum cleaner conduit 5 further includes a first suction tube 11 comprising a proximal end portion 11.1 fluidly and mechanically connected to the first rigid conduit part 7, and a distal end portion 11.2 configured to be fluidly and mechanically connected to the vacuum cleaner case 3, for example directly in the case of an upright vacuum cleaner, or through a gripping crosshead and a flexible suction conduit in the case of a canister vacuum cleaner. The vacuum cleaner conduit 5 also includes a second suction tube 12 comprising a proximal end portion 12.1 fluidly and mechanically connected to the second rigid conduit part 8, and a distal end portion 12.2 configured to be fluidly and mechanically connected to the nozzle 4.

According to the embodiment represented in the figures, the first rigid conduit part 7 includes a first connection portion 13 which is tubular and which is fluidly and mechanically connected to the proximal end portion 11.1 of the first suction tube 11, and the second rigid conduit part 8 includes a second connection portion 14 which is tubular and which is fluidly and mechanically connected to the proximal end portion 12.1 of the second suction tube 12.

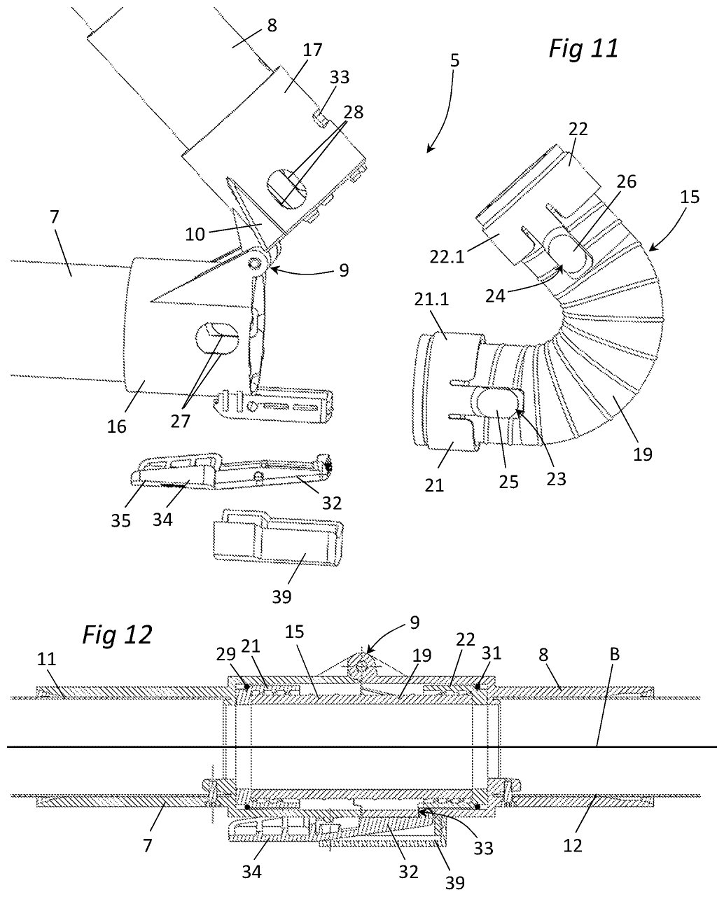

As shown more particularly in FIGS. 5 and 11, the vacuum cleaner conduit 5 further includes a flexible conduit 15 delimiting an internal flow passage and connecting the first and second rigid conduit parts 7, 8. The flexible conduit 15 is more particularly configured to fluidly connect the first and second connection portions 13, 14, such that the first connection portion 13, the second connection portion 14, the first and second suction tubes 11, 12 and the flexible conduit 15 define an air flow passage connected on the one hand to the suction unit 6 and on the other hand to the nozzle 4.

According to the embodiment represented in the figures, the first and second rigid conduit parts 7, 8 respectively include first and second mounting portions 16, 17 which are tubular, and the first and second mounting portions 16, 17 delimit a receiving housing 18 in which is mounted the flexible conduit 15. Advantageously, the first mounting portion 16 includes a first insertion opening and the second mounting portion 17 includes a second insertion opening which is configured to be located facing the first insertion opening when the first and second rigid conduit parts 7, 8 occupy the unfolded configuration.

The flexible conduit 15 includes more particularly a flexible tubular part 19, a first fastening ring 21 which is fastened to a first end portion of the flexible tubular part 19 and which is configured to be removably fastened to the first mounting portion 16, and a second fastening ring 22 which is fastened to a second end portion of the flexible tubular part 19 and which is configured to be removably fastened to the second mounting portion 17. The first fastening ring 21 is more particularly configured to be inserted into the first mounting portion 16 via the first insertion opening, and the second fastening ring 22 is more particularly configured to be inserted into the second mounting portion 17 via the second insertion opening.

According to the embodiment represented in the figures, the first fastening ring 21 includes a first locking device 23 configured to reversibly lock the first fastening ring 21 on the first mounting portion 16, and the second fastening ring 22 includes a second locking device 24 configured to reversibly lock the second fastening ring 22 on the second mounting portion 17.

The first locking device 23 more particularly includes two first locking elements 25, such as first locking arms or first locking tabs, which are diametrically opposed to a central axis of the flexible conduit 15 and which are movable, and advantageously elastically deformable, between a locking configuration in which the two first locking elements 25 are far apart and are configured to cooperate with the first mounting portion 16 so as to lock the first fastening ring 21 on the first mounting portion 16, and an unlocking configuration in which the two first locking elements 25 are brought together and are configured to release the first mounting portion 16 so as to allow a removal of the first fastening ring 21 outside the first mounting portion 16. One of the two first locking elements 25 is particularly visible in FIG. 11, while the other of the two first locking elements 25 is particularly visible in FIG. 4.

Similarly, the second locking device 24 includes two second locking elements 26, such as second locking arms or second locking tabs, which are diametrically opposed to the central axis of the flexible conduit 15 and which are movable, and advantageously elastically deformable, between a locking configuration in which the two second locking elements 26 are far apart and are configured to cooperate with the second mounting portion 17 so as to lock the second fastening ring 22 on the second mounting portion 17, and an unlocking configuration in which the two second locking elements 26 are brought together and are configured to release the second mounting portion 17 so as to allow a removal of the second fastening ring 22 outside the second mounting portion 17. One of the two second locking elements 26 is particularly visible in FIG. 11, while the other of the two second locking elements 26 is particularly visible in FIG. 4.

According to the embodiment represented in the figures, the first fastening ring 21 includes a first annular ring body 21.1 and each of the first locking elements 25 extends from the first annular ring body 21.1 in an extension direction which is substantially parallel to the central axis of the flexible conduit 15 when said first locking element 25 occupies the locking configuration, and the second fastening ring 22 includes a second annular ring body 22.1 and each of the second locking elements 26 extends from the second annular ring body 22.1 in an extension direction which is also substantially parallel to the central axis of the flexible conduit 15 when said second locking element 26 occupies the locking configuration.

Advantageously, each of the first locking elements 25 and of the second locking elements 26 is configured to be accessible from the outside of the vacuum cleaner conduit 5. Each first locking element 25 is more particularly configured to be accessible from one respective lateral side of the first rigid conduit part 7, and each second locking element 26 is more particularly configured to be accessible from a respective lateral side of the second rigid conduit part 8.

When the first and second rigid conduit parts 7, 8 are in the unfolded configuration, each of the first and second locking elements 25, 26 is disposed on a lateral side of the vacuum cleaner conduit 5 between, on the one hand, the articulation device 9 and, on the other hand, the locking member 32. Such a configuration allows an easy access to the two first and the two second locking elements 25, 26 without being hindered by the articulation device 9 or the locking member 32.

According to the embodiment represented in the figures, the first locking device 23 includes two first locking orifices 27 which are provided on the first mounting portion 16, and more particularly on two respective lateral portions of the first mounting portion 16, and which are configured to cooperate respectively with the two first locking elements 25 when the latter are in the locking configuration. Similarly, the second locking device 24 includes two second locking orifices 28 which are provided on the second mounting portion 17, and more particularly on two respective lateral portions of the second mounting portion 17, and which are configured to cooperate respectively with the two second locking elements 26 when the latter are in the locking configuration.

Each first locking orifice 27 is more particularly through and emerges into an external surface of the first mounting portion 16, so as to allow an access to the first respective locking element 25 from the outside of the vacuum cleaner conduit 5 and to allow a displacement of the first respective locking element 25 in the unlocking configuration, and each second locking orifice 28 is more particularly through and emerges into an external surface of the second mounting portion 17, so as to allow an access to the respective second locking element 26 from the outside of the vacuum cleaner conduit 5 and to allow a displacement of the respective second locking element 26 in the unlocking configuration. Each of the first locking orifices 27 and the second locking orifices may for example be oblong. Advantageously, each first locking orifice 27 is configured to be located facing a first locking finger fitted to the respective first locking element 25, when the first fastening ring 21 is fastened to the first rigid conduit part 7, and each second locking orifice 28 is configured to be located facing a second locking finger fitted to the respective second locking element 26, when the second fastening ring 22 is fastened to the second rigid conduit part 8.

As shown in FIG. 11, the flexible conduit 15 further includes a first annular seal 29 fastened to the first fastening ring 21 and configured to sealingly cooperate with the first rigid conduit part 7, and a second annular seal 31 fastened to the second fastening ring 22 and configured to sealingly cooperate with the second rigid conduit part 8.

The vacuum cleaner conduit 5 also includes a locking member 32, such as a locking tab or a locking latch equipped with a locking finger, configured to lock the first and second rigid conduit parts 7, 8 in the unfolded configuration. Advantageously, the locking member 32 and the articulation device 9 are substantially diametrically opposed to a central longitudinal axis B of the vacuum cleaner conduit 5 in the unfolded configuration of the first and second rigid conduit parts 7, 8.

The locking member 32 is pivotally mounted on the first rigid conduit part 7 about a pivot axis C which is parallel to the articulation axis A and between a locking position in which the locking member 32 is configured to cooperate with a locking element 33 (visible in FIG. 11), such as a locking orifice capable of receiving at least partially the aforementioned locking finger, provided on the second rigid conduit part 8 so as to lock the first and second rigid parts 8, 9 in the unfolded configuration, and a release position in which the locking member 32 is configured to release the locking element 33 so as to allow a pivoting of the first and second rigid conduit parts 7, 8 in the folded configuration.

The vacuum cleaner conduit 5 further includes an actuating member 34 configured to move the locking member 32 into the release position. Advantageously, the locking member 32 and the actuating member 34 are made in one single piece, and the actuating member 34 extends in the extension of the locking member 32.

The actuating member 34 is secured in movement to the locking member 32, and is therefore pivotally mounted about the pivot axis C and between a rest position (see FIG. 2) and an unlocking position. The vacuum cleaner conduit 5 is more particularly configured such that a displacement of the actuating member 34 from the rest position to the unlocking position causes a displacement of the locking member 32 from the locking position to the release position.

The actuating member 34 includes an actuating part 35 configured to be manually actuated by a user, and a connecting part 36 connecting the actuating part 35 to the locking member 32.

The actuating part 35 includes more particularly a bearing surface 37 against which a user is able to exert a bearing force, that is to say a pressure, so as to move the actuating member 34 into the unlocking position. According to the embodiment represented in the figures, the actuating part 35 includes a rear transverse edge which defines the rear transverse edge of the actuating member 34.

Advantageously, the actuating part 35 and the locking member 32 are located on the same side of the vacuum cleaner conduit 5 which is diametrically opposed to the side of the vacuum cleaner conduit 5 where is located the articulation device 9, and the actuating part 35 and the locking member 32 are substantially aligned in a longitudinal direction.

As shown in FIG. 10, the actuating part 35 is curved and extends around a portion of the outer periphery of the first rigid conduit part 7. Thus, the inner face 35.1 of the actuating part 35, which is located facing the first rigid conduit part 7, is concave and rounded, and the bearing surface 37 is convex and rounded. Advantageously, the inner face 35.1 of the actuating part 35 has a curvature substantially complementary to the outer curvature of the first rigid conduit part 7. Such a configuration of the actuating member 34 makes it possible to increase the displacement stroke, namely the deflection, of the actuating member 34 during its displacements between the rest and unlocking positions, while limiting the bulk of the actuating member 34.

According to the embodiment represented in the figures, the connecting part 36 is elongated and extends parallel to the central longitudinal axis B of the vacuum cleaner conduit 5 when the first and second rigid conduit parts 7, 8 are in the unfolded configuration, and the actuating part 35 extends from a rear transverse edge of the connecting part 36 and is therefore located opposite the locking member 32 relative to the pivot axis C. Advantageously, the actuating part 35 is configured to be located entirely set back from a plane which is parallel to the articulation axis A and which contains the central longitudinal axis B of the vacuum cleaner conduit 5 when the first and second rigid conduit parts 7, 8 are in the unfolded configuration.

According to the embodiment represented in the figures, the actuating part 35 has a first longitudinal dimension, measured parallel to the central longitudinal axis B of the vacuum cleaner conduit 5 in the unfolded configuration of the first and second rigid conduit parts 7, 8, and the locking member 32 has a second longitudinal dimension, measured parallel to the central longitudinal axis B of the vacuum cleaner conduit 5 in the unfolded configuration of the first and second rigid conduit parts 7, 8, which is less than the first longitudinal dimension. Advantageously, the locking member 32 has a transverse dimension, measured perpendicular to a median longitudinal plane of the vacuum cleaner conduit 5 in the unfolded configuration of the first and second rigid conduit parts 7, 8, which is less than the first longitudinal dimension of the actuating part 35.

The vacuum cleaner conduit 5 further includes a biasing element 38, such as a biasing spring, configured to bias the actuating member 34 into the rest position. Such a biasing element 38 makes it possible to define a stable rest position for the actuating member 34.

The vacuum cleaner conduit 5 also includes a covering member 39, such as a covering hood, which is fastened to the first rigid conduit part 7 and which is configured to extend under the locking member 32 and to completely cover the lower face of the locking member 32, that is to say the face of the locking member 32 which is located opposite the first rigid conduit part 7.

The covering member 39 is in particular configured to cover a distal end portion of the locking member 32. Advantageously, the covering member 39 is also configured to completely cover the lateral edges of the locking member 32, and to make the locking member 32 inaccessible when the first and second rigid conduit parts 7, 8 occupy the unfolded configuration. Such a covering member 39 considerably limits the risks of the locking member 32 seizing and also the risks of pinching a user's fingers when the locking member 32 pivots between the locking position and the release position.

The covering member 39 includes more particularly a main covering wall 39.1 which extends parallel to a central axis of the first rigid conduit part 7 and which is configured such that, when the first and second rigid conduit parts 7, 8 are in the unfolded configuration, the distal end portion of the locking member 32 is disposed between the main covering wall 39.1 and the second rigid conduit part 8. The main covering wall 39.1 is configured to extend under the locking member 32 when the vacuum cleaner conduit 5 is in a normal configuration of use.

When the first and second rigid conduit parts 7, 8 are in the unfolded configuration, the radial distance between an internal surface of the main covering wall 39.1 and an outer surface of the second rigid conduit part 8 is sufficient to allow a deflection of the distal end portion of the locking member 32 when the locking member 32 is moved from the locking position to the release position.

The covering member 39 further includes two lateral walls 39.2 extending on either side of the locking member 32 and an end wall 39.3 located opposite the actuating part 35.

According to the embodiment represented in the figures, the second rigid conduit part 8 and the covering member 39 delimit, when the first and second rigid conduit parts 7, 8 are in the unfolded configuration, an internal housing in which is housed the locking member 32.

Advantageously, the covering member 39 extends longitudinally beyond the pivot axis C of the locking member 32, but the actuating member 34 extends longitudinally beyond the covering member 39 such that the actuating part 35 is not covered by the covering member 39, in order to allow an easy actuation of the actuating part 35 by a user.

As shown more particularly in FIGS. 2, the bearing surface 37 is substantially flush with an outer surface 41 of the covering member 39 when the actuating member 34 occupies the rest position. For this purpose, the actuating member 34 may for example include a transverse shoulder 42 which separates the connecting part 36 and the actuating part 35 and which is configured such that a lower surface of the connecting part 36 is raised relative to the bearing surface 37, that is to say is offset upwards relative to the bearing surface 37, by a distance corresponding substantially to the thickness of the main covering wall 39.1 of the covering member 39.

Advantageously, the actuating part 35 includes two outer lateral surfaces 43 which are also substantially flush respectively with two outer lateral surfaces 44 of the covering member 39 (see FIG. 3). Each outer lateral surface 43 of the actuating part 35 may advantageously be parallel to the respective outer lateral surface 44 of the covering member 39.

Of course, the present invention is in no way limited to the embodiment described and illustrated which has only been given by way of example. Modifications remain possible, particularly from the point of view of the constitution of the various elements or by substitution of technical equivalents, without departing from the scope of protection of the invention.

1. A vacuum cleaner conduit (5) defining an air flow passage and comprising:
a first rigid conduit part (7) and a second rigid conduit part (8),
an articulation device (9) connecting the first and second rigid conduit parts (7, 8) together, the articulation device (9) including an articulation axis (A) and being configured to allow a pivoting of the first rigid conduit part (7) relative to the second rigid conduit part (8) about the articulation axis (A) and between an unfolded configuration in which the first and second rigid conduit parts (7, 8) are substantially aligned with each other and a folded configuration in which the first and second rigid conduit parts (7, 8) define between them an angle less than 180°,
a locking member (32) configured to lock the first and second rigid conduit parts (7, 8) in the unfolded configuration, the locking member (32) being pivotally mounted on one of the first and second rigid conduit parts (7, 8) about a pivot axis (C) which is substantially parallel to the articulation axis (A) and being configured to pivot between a locking position in which the locking member (32) is configured to cooperate with the other of the first and second rigid conduit parts (7, 8) so as to lock the first and second rigid conduit parts (7, 8) in the unfolded configuration, and a release position in which the locking member (32) is configured to release the other of the first and second rigid conduit parts (7, 8) so as to allow a pivoting of the first and second rigid conduit parts (7, 8) in the folded configuration, and
an actuating member (34) secured in movement to the locking member (32) and including an actuating part (35) configured to be manually actuated by a user, the locking member (32) and the actuating part (35) being substantially diametrically opposed to the articulation device (9) with respect to a central longitudinal axis (B) of the vacuum cleaner conduit (5) when the first and second rigid conduit parts (7, 8) are in the unfolded configuration, the actuating member (34) being pivotally mounted about the pivot axis (C) between a rest position and an unlocking position, the vacuum cleaner conduit (5) being configured such that a displacement of the actuating member (34) from the rest position to the unlocking position causes a displacement of the locking member (32) from the locking position to the release position,
characterized in that the vacuum cleaner conduit (5) includes a covering member (39) configured to cover at least a distal end portion of the locking member (32), the covering member (39) including a main covering wall (39.1) which is configured such that, when the first and second rigid conduit parts (7, 8) are in the unfolded configuration, the distal end portion of the locking member (32) is disposed between the main covering wall (39.1) and the other of the first and second rigid conduit parts (7, 8).

2. The vacuum cleaner conduit (5) according to claim 1, wherein, when the first and second rigid conduit parts (7, 8) are in the unfolded configuration, a radial distance between an internal surface of the main covering wall (39.1) and an outer surface of the other of the first and second rigid conduit parts (7, 8) is sufficient to allow a deflection of the distal end portion of the locking member (32) when the locking member (32) is moved from the locking position to the release position.

3. The vacuum cleaner conduit (5) according to claim 1 or 2, wherein the actuating part (35) includes a bearing surface (37) against which a user is able to exert a bearing force so as to move the actuating member (34) into the unlocking position, the bearing surface (37) is located set back from or is substantially flush with an outer surface (41) of the main covering wall when the actuating member (34) occupies the rest position.

4. The vacuum cleaner conduit (5) according to any one of claims 1 to 3, wherein the covering member (39) is configured to laterally cover the locking member (32).

5. The vacuum cleaner conduit (5) according to any one of claims 1 to 4, wherein the actuating part (35) includes two outer lateral surfaces which are substantially flush respectively with two outer lateral surfaces of the covering member (39).

6. The vacuum cleaner conduit (5) according to claim 5, wherein each outer lateral surface of the actuating part (35) is substantially parallel to the respective outer lateral surface of the covering member (39).

7. The vacuum cleaner conduit (5) according to any one of claims 1 to 6, wherein the actuating part (35) includes an inner face (35.1) which is located facing one of the first and second rigid conduit parts (7, 8), the inner face (35.1) of the actuating part (35) being concave and rounded.

8. The vacuum cleaner conduit (5) according to any one of claims 1 to 7, wherein the actuating member (34) and the locking member (32) are pivotally mounted on the first rigid conduit part (7), the covering member (39) being fastened to the first rigid conduit part (7).

9. The vacuum cleaner conduit (5) according to claim 8, herein the second rigid conduit part (8) and the covering member (39) delimit, when the first and second rigid conduit parts (7, 8) are in the unfolded configuration, an internal housing in which is housed the locking member (32).

10. The vacuum cleaner conduit (5) according to any one of claims 1 to 9, wherein the covering member (39) is configured to make the locking member (32) inaccessible when the first and second rigid conduit parts (7, 8) occupy the unfolded configuration.

11. The vacuum cleaner conduit (5) according to any one of claims 1 to 10, wherein the covering member (39) extends longitudinally beyond the pivot axis (C) of the locking member (32).

12. The vacuum cleaner conduit (5) according to any one of claims 1 to 11, wherein the locking member (32) and the actuating member (34) are made in one single piece.

13. The vacuum cleaner conduit (5) according to any one of claims 1 to 12, wherein the articulation device (9) is configured to be located above a portion of the air flow passage which extends near the articulation device (9), when the vacuum cleaner conduit (5) is in normal conditions of use.

14. The vacuum cleaner conduit (5) according to any one of claims 1 to 13, wherein the first rigid conduit part (7) is configured to be fluidly connected to a vacuum cleaner case (3) equipped with a suction unit (6), and the second rigid conduit part (8) is configured to be fluidly connected to a nozzle (4) configured to be in contact with a floor to be cleaned.

15. The vacuum cleaner conduit (5) according to any one of claims 1 to 14, which includes at least one biasing element (38) configured to bias the actuating member (34) into the rest position and/or the locking member (32) in the locking position.

16. The vacuum cleaner conduit (5) according to any one of claims 1 to 15, which includes a flexible conduit (15) connecting the first and second rigid conduit parts (7, 8) and at least partially defining the air flow passage.

17. The vacuum cleaner conduit (5) according to claim 16, wherein the flexible conduit (15) includes a flexible tubular part (19), a first fastening ring (21) which is fastened to a first end portion of the flexible tubular part (19) and which is configured to be removably fastened to the first rigid conduit part (7), and a second fastening ring (22) which is fastened to a second end portion of the flexible tubular part (19) and which is configured to be removably fastened to the second rigid conduit part (8).

18. The vacuum cleaner conduit (5) according to claim 17, wherein the first fastening ring (21) includes a first locking device (23) configured to reversibly lock the first fastening ring (21) on the first rigid conduit part (7), and the second fastening ring (22) includes a second locking device (24) configured to reversibly lock the second fastening ring (22) on the second rigid conduit part (8).

19. A vacuum cleaner (2) including:
a vacuum cleaner case (3) equipped with a suction unit,
a nozzle (4) configured to be in contact with a floor to be cleaned, and
a vacuum cleaner conduit (5) according to any one of the preceding claims, the vacuum cleaner conduit (5) mechanically and fluidly connecting the vacuum cleaner case (3) to the nozzle (4).
